(19) United States
(12) Patent Application Publication
(10) Pub. No.: US 2015/0326963 A1
(43) Pub. Date: Nov. 12, 2015

(54) Real-time Control Of An Acoustic Environment

(71) Applicant: GN Store Nord A/S, Ballerup (DK)

(72) Inventors: Peter Schou SØRENSEN, Valby (DK); Peter MOSSNER, Kastrup (DK)

(21) Appl. No.: 14/687,386

(22) Filed: Apr. 15, 2015

(30) Foreign Application Priority Data
May 8, 2014 (EP) 14167461

(51) Int. Cl. H04R 1/10; H04R 3/12

(52) U.S. Cl. CPC H04R 1/1041; H04R 3/12; H04R 2420/07

(57) ABSTRACT

Disclosed is a system for providing an acoustic environment for one or more users present in a physical area, the system comprising:
one or more wireless hearing devices, where the one or more wireless hearing devices are configured to be worn by the one or more users, and where each wireless hearing device is configured to emit a sound content to the respective user;
a control device configured to be operated by a master, where the control device comprises:
   at least one sound source comprising the sound content;
   a transmitter for wirelessly transmitting the sound content to the one or more wireless hearing devices;
      where the control device is configured for controlling the sound content transmitted to the one or more wireless hearing devices;
      where the control device is configured for controlling the location of one or more virtual sound sources in the area in relation to the one or more users; and
      wherein the control device is configured for transmitting different sound content to different hearing devices worn by users or to hearing devices worn by different groups of users of the one or more users.

### FIELD OF INVENTION

The invention relates to a system for providing an acoustic environment for one or more users present in a physical area. In particular, the invention relates to such a system comprising one or more wireless hearing devices, where the one or more wireless hearing devices are configured to be worn by the one or more users.

### BACKGROUND

U.S. Pat. No. 7,116,789B (Dolby) discloses a system for providing a listener with an augmented audio reality in a geographical environment, the system comprising: a position locating system configured to determine a current position and orientation of a listener in the geographical environment, the geographical environment being a real environment at which one or more items of potential interest are located, each item of potential interest having an associated predetermined audio track; an audio track retrieval system configured to retrieve for any one of the items of potential interest the audio track associated with the item and having a predetermined spatialization component dependent on the location of the item of potential interest associated with the audio track in the geographical environment; an audio track rendering system adapted to render an input audio signal based on any one of the associated audio tracks to a series of speakers such that the listener experiences a sound that appears to emanate from the location of the item of potential interest to which is associated the audio track that the input audio signal is based on; and an audio track playback system interconnected to the position locating system and the audio track retrieval system arranged such that the system automatically ascertains using the current listener position and orientation, the spatial relationship between the listener and the items of potential interest, the playback system configured to automatically ascertain which audio track, if any, to automatically forward to the rendering system according to the ascertained relationship to the items of potential interest, and further configured to forward the ascertained audio tracks to the audio rendering system for rendering depending on the current position and orientation of the listener in the geographical environment and the ascertained relationship, such that the listener for any particular item of potential interest for which an audio track has been forwarded, has the sensation that the forwarded audio track associated with the particular item is emanating from the location in the geographical environment of the particular item of interest.

However, it remains a problem to improve systems providing a differentiated acoustic environment for one or more users present in a physical area.

### SUMMARY

Disclosed is a system for providing an acoustic environment for one or more users present in a physical area, the system comprising:
one or more wireless hearing devices, where the one or more wireless hearing devices are configured to be worn by the one or more users, and where each wireless hearing device is configured to emit a sound content to the respective user;
a control device configured to be operated by a master, where the control device comprises:
   at least one sound source comprising the sound content;
   a transmitter for wirelessly transmitting the sound content to the one or more wireless hearing devices;
      where the control device is configured for controlling the sound content transmitted to the one or more wireless hearing devices;
      where the control device is configured for controlling the location of one or more virtual sound sources in the area in relation to the one or more users; and
      wherein the control device is configured for transmitting different sound content to different hearing devices worn by users or to hearing devices worn by different groups of users of the one or more users.

It is an advantage that different users of groups of users can experience different sound content, i.e. the users can have individual sound experiences. This may be an advantage at a disco if guests or users for example prefer listening to different music. In a teaching situation it may be an advantage if pupils or users are on different levels and therefore need to have different teaching. It may be an advantage in a war simulation case for soldiers, if different groups of soldiers should receive different orders or simulate being in different surroundings etc. Thus the system can be used to fx test how people react under stress, e.g. soldiers under fire, children learning to handle themselves in traffic situations, games etc.

Thus the control device is configured to transmit individual sound content, such as a first sound content to a first user or to a first group of users, and a second sound content to a second user or to a second group of users, whereby the first user or group of users receive a different sound content than the second user or group of users.

It is an advantage that the control device is configured to control an individual, personal or in group acoustic environment and sound content. Thus the acoustic scene can be designed by the master to exactly fit the users in a certain case.

Thus, one user, or one group of users, may have one musical experience while another user, or group of users, may have another musical experience. Each user's musical experience is influenced not only by the master or DJ, but also by the location and head direction of the user at any given time, due to for example the one or more virtual sound sources.

The virtual sound sources can be moved around by the master or have a fixed position. For example one virtual sound source may be placed in a certain corner, while another virtual sound source may be moved around. When a user turns towards a certain virtual sound source, the user may hear this virtual sound source differently than another which is not turned towards the virtual sound source. The virtual sound sources may be placed at any XYZ coordinate.

The control device is configured for controlling the location of one or more virtual sound sources in the area in relation to the one or more users, where the location may be the apparent location of the virtual sound sources.

The physical area may be an indoor and/or outdoor area, such as a disco, a class room, a soldier training field, a room or field for gaming etc. The physical area may be a bounded area, an outlined area, a demarcated area, a delimited area, a defined area, a restricted area, such as an area of 10 square metres, 20 square metres, 40 square metres, 80 square metres, 100 square metres, 200 square metres, 500 square metres, 1000 square metres etc.

In some embodiments the control device is configured for controlling the sound content in real time.

It is an advantage because the master can then change the sound content immediately or instantanously, fx the music, for one or more users, e.g. a group of users, if the area is a disco, and the master decides that the music should change to a different genre or with a different tempo in order to ensure that the users, which are dancing, keep dancing such that the party continues.

In some embodiments the sound content transmitted to a user is dependent on the user's physical position in the area.

It is an advantage that the master fx transmits different music genre to different groups of user, such that if a user wishes to hear and dance to rock music, he or she can move to the left corner of the area, whereto the master transmits sound content of rock music, or if a user wishes to hear pop music, the user can move to the right corner of the area whereto the master transmits sound content of pop music etc.

In some embodiments sound content transmitted to a user changes when the user changes his/her physical position in the area.

In some embodiments the HRTF is applied to the sound content in the one or more hearing devices.

In some embodiments the hearing device comprises a sound generator connected for outputting the sound content to the user via a pair of filters with a Head-Related Transfer Function and connected between the sound generator and a pair of loudspeakers of the hearing device for generation of a binaural sound content emitted towards the eardrums of the user.

In some embodiments the coordinates of the one or more virtual sound sources are transmitted to the processor of the hearing device, whereby the Head-Related Transfer Function is applied to the one or more virtual sound sources in the hearing device.

In some embodiments the HRTF is applied to the sound content in the control device.

In some embodiments the control device continuously receives position data of the one or more users transmitted from the one or more hearing devices, respectively.

In some embodiments the one or more users are persons wearing the wireless hearing devices.

In some embodiments a group of users is two or more users.

In some embodiments the group of users are persons present in the same sub area of the physical area.

In some embodiments a first group of users are persons who receive a first sound content in their hearing devices.

In some embodiments a second group of users are persons receiving a second sound content in their hearing devices.

In some embodiments the master is a person controlling the control device.

In some embodiments the master is a user.

In some embodiments the apparent location of the one or more virtual sound sources is a part of and/or is included in the sound content.

In some embodiments the apparent location of the one or more virtual sound sources is not part of and/or is excluded from and/or separate from the sound content.

In some embodiments the one or more virtual sound sources are music instruments, such as drums, guitar, and/or keyboard.

In some embodiments the one or more virtual sound sources are nature sounds, such as bird song, wind, and/or waves.

In some embodiments the one or more virtual sound sources are war sounds, such as machine guns, tanks, and/or explosions.

In some embodiments the hearing device comprises two or more loudspeakers for emission of sound towards the user's ears, when the hearing devices is worn by the user in its intended operational position on the users head.

In some embodiments the hearing device is an Ear-Hook, In-Ear, On-Ear, Over-the-Ear, Behind-the-Neck, helmet, headguard, headset, earphone, ear defenders, or earmuffs.

In some embodiments the hearing device comprises a headband or a neckband.

In some embodiments the headband or neckband comprises an electrical connection between the two or more loudspeakers.

In some embodiments the hearing device is an hearing aid.

In some embodiments the hearing aid is a binaural hearing aid, such as a BTE, a RIE, an ITE, an ITC, or a CIC.

In some embodiments the hearing devices comprises a satellite navigation system unit and a satellite navigation system antenna for, when the hearing device is placed in its intended operational position on the head of the user, determining the geographical position of the user, based on satellite signals.

In some embodiments the satellite navigation system antenna is accommodated in the headband or neckband of the hearing device.

In some embodiments the satellite navigation system is the Global Positioning System (GPS).

In some embodiments the one or more hearing devices comprise an audio interface for reception of the sound content from the control device.

In some embodiments audio interface is a wireless interface, such as wireless local area network (WLAN) or Bluetooth interface.

In some embodiments the hearing devices comprise an inertial measurement unit.

In some embodiments the inertial measurement unit is accommodated in the headband or neckband of the hearing device.

In some embodiments the inertial measurement unit is configured to determine the position of the hearing device.

In some embodiments the system comprises an inertial navigation system comprising a computer, in the control device and/or in the hearing device, motion sensors, such as accelerometers, in the one or more hearing devices and/or rotation sensors, such as gyroscopes, in the one or more hearing devices, and/or magnetometers for continuously calculating, via dead reckoning, the position, and/or orientation, and/or velocity of the one or more users without the need for external references.

In some embodiments the orientation of the head of the user is defined as the orientation of a head reference coordinate system with relation to a reference coordinate system with a vertical axis and two horizontal axes at the current location of the user.

In some embodiments a head reference coordinate system is defined with its centre located at the centre of the user's head, which is defined as the midpoint of a line drawn between the respective centres of the eardrums of the left and right ears of the user, where the x-axis of the head reference coordinate system is pointing ahead through a centre of the nose of the user, its y-axis is pointing towards the left ear through the centre of the left eardrum, and its z-axis is pointing upwards.

In some embodiments head yaw is the angle between the current x-axis' projection onto a horizontal plane at the location of the user and a horizontal reference direction, such as magnetic north or true north, where head pitch is the angle between the current x-axis and the horizontal plane, where head roll is the angle between the y-axis and the horizontal plane, and where the x-axis, y-axis, and z-axis of the head reference coordinate system are denoted the head x-axis, the head y-axis, and the head z-axis, respectively.

In some embodiments the inertial measurement unit comprises accelerometers for determination of displacement of the hearing device, where the inertial measurement unit determines head yaw based on determinations of individual displacements of two accelerometers positioned with a mutual distance for sensing displacement in the same horizontal direction, when the user wears the hearing device.

In some embodiments the inertial measurement unit determines head yaw utilizing a first gyroscope, such as a solid-state or MEMS gyroscope, positioned for sensing rotation of the head x-axis projected onto a horizontal plane at the user's location with respect to a horizontal reference direction.

In some embodiments the inertial measurement unit comprises further accelerometers and/or further gyroscope(s) for determination of head pitch and/or head roll, when the user wears the hearing device in its intended operational position on the user's head.

In some embodiments, in order to facilitate determination of head yaw with relation, such as to True North or Magnetic North of the earth, the inertial measurement comprises a compass, such as a magnetometer.

In some embodiments the inertial measurement unit comprises one, two or three axis sensors which provide information of head yaw, and/or head yaw and head pitch, and/or head yaw, head pitch, and head roll, respectively.

In some embodiments the inertial measurement unit comprises sensors which provide information on one, two or three dimensional displacement.

In some embodiments the one or more hearing devices comprise a data interface for transmission of data from the inertial measurement unit to the control device.

In some embodiments the control device comprises a data interface for receiving data from the inertial measurement units in the one or more hearing devices.

In some embodiments the data interface is a wireless interface.

In some embodiments the data interface is a wireless local area network (WLAN) or Bluetooth interface.

In some embodiments the data interface and the audio interface is combined into a single interface, such as a wireless local area network (WLAN) or Bluetooth interface.

In some embodiments the hearing device comprises a processor with inputs connected to the one or more sensors of the inertial measurement unit, and where the processor is configured for determining and outputting values for head yaw, and optionally head pitch and/or optionally head roll, when the user wears the hearing device in its intended operational position on the user's head.

The processor may further have inputs connected to displacement sensors of the inertial measurement unit, and configured for determining and outputting values for displacement in one, two or three dimensions of the user when the user wears the hearing device in its intended operational position on the user's head.

In some embodiments the hearing device is equipped with a complete attitude heading reference system (AHRS) for determination of the orientation of the user's head, where the AHRS comprises solid-state or MEMS gyroscopes, and/or accelerometers and/or magnetometers on all three axes.

In some embodiments a processor of the AHRS provides digital values of the head yaw, head pitch, and head roll based on the sensor data.

In some embodiments the one or more hearing devices comprise an ambient microphone for receiving ambient sound for user selectable transmission towards at least one of the ears of the user.

In some embodiments the one or more hearing devices comprise a user interface, such as a push button, configured for switching the ambient microphone on or off.

In some embodiments the one or more hearing devices comprise an attached microphone configured for receiving a sound signal from the user of the hearing device, and where the received sound signal is configured to be transmitted to another user, such that the users are able to communicate simultaneously with hearing sound content in the hearing device.

In some embodiments the sound player of the control device comprises one or more music players, such as CD players, vinyl record players, laptop computers, and/or MP3 players.

In some embodiments the system further comprises a master hearing device for the master, and/or a microphone for the master.

In some embodiments the control device comprises an audio mixer configured for enabling the master to redirect music from a player, whose sound content is not outputted to the users, to the master hearing device so the master can preview/pre-hear an upcoming song.

In some embodiments the control device comprises an audio mixer configured for enabling the master to redirect music from a non-playing music player to the master hearing device so the master can preview/pre-hear an upcoming song.

In some embodiments the control device comprises a mixer comprising a crossfader configured for enabling the master to perform a transition from transmitting sound content from one music player to another music player.

In some embodiments the control device comprises audio sampling hardware and software, pressure and/or velocity sensitive pads configured to add instrument sounds, other than those coming from the music player, to the sound content transmitted to the user.

In some embodiments the control device comprises a transmitter for wirelessly transmitting the sound content to the one or more hearing devices, and where the transmitter is a radio transmitter for outputting at least one wireless channel, where each wireless channel is configured for carrying the sound content and data pertinent to the location of the one or more virtual sound sources.

In some embodiments the control device is configured for controlling the loudness of the sound content transmitted to the one or more hearing devices.

In some embodiments the control device comprises a user interface, such as a screen, providing the master with a physical overview of the virtual sound sources and/or of the users or groups of users.

In some embodiments the control device comprises a server.

In some embodiments two or more control devices operate in the physical area.

In some embodiments the system comprises a local indoor positioning system/indoor location system for determining the position of each of the users in the area.

In some embodiments the indoor location system uses radiation such as infrared radiation, radio waves, visible light to determine the position of each of the users.

In some embodiments the indoor location system uses sound, such as ultrasound, to determine the position of the users.

In some embodiments the indoor location system uses physical contact, such as the physical contact between the user's feet or shoes and the floor, to determine the position of the users.

In some embodiments the indoor location system uses electrical contact, such as the electrical contact between the user's shoes and the floor, to determine the position of the users.

In some embodiments the control device comprises means to rhythmically synchronize at least two of the virtual sound sources.

In some embodiments the means to rhythmically synchronize at least two of the virtual sound sources comprises providing beat matching of the virtual sound sources for one or more users or one or more groups of users, whereby the users hear different music but with the same beat.

In some embodiments the control device comprises means to rhythmically synchronize at least two sound players having different sound content.

In some embodiments the means to rhythmically synchronize at least two sound players comprises providing beat matching of the sound content for one or more users or one or more groups of users, whereby the users hear different music but with the same beat.

In some embodiments the control device is configured for providing pitch shifting of the sound content for one or more users or one or more groups of users, whereby the users hear different music but with the same pitch shift.

In some embodiments the control device is configured for providing tempo stretching of the sound content for one or more users or one or more groups of users, whereby the users hear different music but with the same tempo.

Also disclosed is a hearing device configured to be head worn and having loudspeakers for emission of sound towards the ears of a user and accommodating an inertial measurement unit positioned for determining head yaw, when the user wears the hearing device in its intended operational position on the user's head, the hearing device comprising:
a GPS unit for determining the geographical position of the user,
a sound generator connected for outputting sound content to the loudspeakers, and
a pair of filters with a Head-Related Transfer Function connected between the sound generator and each of the loudspeakers in order to generate a binaural sound content emitted towards each of the eardrums of the user and perceived by the user as coming from one or more sound sources positioned in one or more directions corresponding to the selected Head Related Transfer Function.

The hearing device may be an Ear-Hook, In-Ear, On-Ear, Over-the-Ear, Behind-the-Neck, Helmet, Headguard, etc, headset, headphone, earphone, ear defender, earmuff, etc.

Further, the hearing device may be a binaural hearing aid, such as a BTE, a RIE, an ITE, an ITC, a CIC, etc. binaural hearing aid.

The hearing device may have a headband carrying two earphones. The headband is intended to be positioned over the top of the head of the user as is well-known from conventional headsets and headphones with one or two earphones. The inertial measurement unit may be accommodated in the headband of the hearing device.

The hearing device may have a neckband carrying two earphones. The neckband is intended to be positioned behind the neck of the user as is well-known from conventional neckband headsets and headphones. The inertial measurement unit may be accommodated in the neckband of the hearing device.

The hearing device may comprise a data interface for transmission of data from the inertial measurement unit to the control device.

The data interface may be a wireless interface, such as WLAN or a Bluetooth interface, e.g. a Bluetooth Low Energy interface.

The hearing device may comprise an audio interface for reception of an audio signal from a hand-held device, such as mobile phone.

The audio interface may be a wired interface or a wireless interface.

The data interface and the audio interface may be combined into a single interface, e.g. a WLAN interface, a Bluetooth interface, etc.

The hearing device may for example have a Bluetooth Low Energy data interface for exchange of head jaw values and control data between the hearing device and the control device, and a wired audio interface for exchange of audio signals between the hearing device and the hand-held device.

The hearing device may comprise an ambient microphone for receiving ambient sound for user selectable transmission towards at least one of the ears of the user.

In the event that the hearing device provides a sound proof, or substantially, sound proof, transmission path for sound emitted by the loudspeaker(s) of the hearing device towards the ear(s) of the user, the user may be acoustically disconnected in an undesirable way from the surroundings.

The hearing device may have a user interface, e.g. a push button, so that the user can switch the microphone on and off as desired thereby connecting or disconnecting the ambient microphone and one loudspeaker of the hearing device.

The hearing device may have a mixer with an input connected to an output of the ambient microphone and another input connected to an output of the hand-held device supplying an audio signal, and an output providing an audio signal that is a weighted combination of the two input audio signals.

The user input may further include means for user adjustment of the weights of the combination of the two input audio signals, such as a dial, or a push button for incremental adjustment.

The hearing device may have a threshold detector for determining the loudness of the ambient signal received by the ambient microphone, and the mixer may be configured for including the output of the ambient microphone signal in its output signal only when a certain threshold is exceeded by the loudness of the ambient signal.

Further ways of controlling audio signals from an ambient microphone and a voice microphone is disclosed in US 2011/0206217 A1.

The hearing device may also have a GPS-unit for determining the geographical position of the user based on satellite signals in the well-known way. Hereby, the hearing device can provide the user's current geographical position based on the GPS-unit and the orientation of the user's head based on data from the hearing device.

The GPS-unit may be included in the inertial measurement unit of the hearing device for determining the geographical position of the user, when the user wears the hearing device in its intended operational position on the head, based on satellite signals in the well-known way. Hereby, the user's current position and orientation can be provided to the user based on data from the hearing device.

The hearing device may accommodate a GPS-antenna, whereby reception of GPS-signals is improved in particular in urban areas where, presently, reception of GPS-signals can be difficult.

The inertial measurement unit may also have a magnetic compass for example in the form of a tri-axis magnetometer facilitating determination of head yaw with relation to the magnetic field of the earth, e.g. with relation to Magnetic North.

The hearing device comprises a sound generator connected for outputting audio signals to the loudspeakers via the pair of filters with a Head-Related Transfer Function and connected between the sound generator and the loudspeakers for generation of a binaural acoustic sound signal emitted towards the eardrums of the user. The pair of filters with a Head-Related Transfer Function may be connected in parallel between the sound generator and the loudspeakers.

The performance, e.g. the computational performance, of the hearing device may be augmented by using a hand held device or terminal, such as a mobile phone, in conjunction with the hearing device.

A personal hearing system is provided, comprising a hearing device configured to be head worn and having loudspeakers for emission of sound towards the ears of a user and accommodating an inertial measurement unit positioned for determining head yaw, when the user wears the hearing device in its intended operational position on the user's head,

a GPS unit for determining the geographical position of the user,
a sound generator connected for outputting audio signals to the loudspeakers, and
a pair of filters with a Head-Related Transfer Function connected between the sound generator and each of the loudspeakers in order to generate a binaural acoustic sound signal emitted towards each of the eardrums of the user and perceived by the user as coming from a sound source positioned in a direction corresponding to the selected Head Related Transfer Function.

Preferably, the personal navigation system further has a processor configured for

determining a direction towards a desired geographical destination with relation to the determined geographical position and head yaw of the user,
controlling the sound generator to output audio signals, and selecting a Head Related Transfer Function for the pair of filters corresponding to the determined direction towards the desired geographical destination so that the user perceives the sound as arriving from a sound source located in the selected direction.

The personal hearing system may also comprise a hand-held device, such as a GPS-unit, a smart phone, e.g. an Iphone, an Android phone, etc, e.g. with a GPS-unit, etc, interconnected with the hearing device.

The hearing device may comprise a data interface for transmission of data from the inertial measurement unit to the hand-held device.

The data interface may be a wired interface, e.g. a USB interface, or a wireless interface, such as a Bluetooth interface, e.g. a Bluetooth Low Energy interface.

The hearing device may comprise an audio interface for reception of an audio signal from the hand-held device.

The audio interface may be a wired interface or a wireless interface.

The data interface and the audio interface may be combined into a single interface, e.g. a USB interface, a Bluetooth interface, etc.

The hearing device may for example have a Bluetooth Low Energy data interface for exchange of head jaw values and control data between the hearing device and the hand-held device, and a wired audio interface for exchange of audio signals between the hearing device and the hand-held device.

Based on received head yaw values, the hand-held device can display maps on the display of the hand-held device in accordance with orientation of the head of the user as projected onto a horizontal plane, i.e. typically corresponding to the plane of the map. For example, the map may be displayed with the position of the user at a central position of the display, and the current head x-axis pointing upwards.

The user may calibrate directional information by indicating when his or her head x-axis is kept in a known direction, for example by pushing a certain push button when looking due North, typically True North. The user may obtain information on the direction due True North, e.g. from the position of the Sun on a certain time of day, or the position of the North Star, or from a map, etc.

The hearing device may have a microphone for reception of spoken commands by the user, and the processor may be configured for decoding of the spoken commands and for controlling the personal hearing system to perform the actions defined by the respective spoken commands.

The hearing device may have a mixer with an input connected to an output of the ambient microphone and another input connected to an output of the hand-held device supplying an audio signal, and an output providing an audio signal that is a weighted combination of the two input audio signals.

The user input may further include means for user adjustment of the weights of the combination of the two input audio signals, such as a dial, or a push button for incremental adjustment.

The personal hearing system also has a GPS-unit for determining the geographical position of the user based on satellite signals in the well-known way. Hereby, the personal hearing system can provide the user's current geographical position based on the GPS-unit and the orientation of the user's head based on data from the hearing device.

The GPS-unit may be included in the inertial measurement unit of the hearing device for determining the geographical position of the user, when the user wears the hearing device in its intended operational position on the head, based on satellite signals in the well-known way. Hereby, the user's current position and orientation can be provided to the user based on data from the hearing device.

Alternatively, the GPS-unit may be included in the hand-held device that is interconnected with the hearing device. The hearing device may accommodate a GPS-antenna that is connected with the GPS-unit in the hand-held device, whereby reception of GPS-signals is improved in particular in urban areas where, presently, reception of GPS-signals by hand-held GPS-units can be difficult.

The inertial measurement unit may also have a magnetic compass for example in the form of a tri-axis magnetometer facilitating determination of head yaw with relation to the magnetic field of the earth, e.g. with relation to Magnetic North.

The personal hearing system comprises a sound generator connected for outputting audio signals to the loudspeakers via the pair of filters with a Head-Related Transfer Function and connected in parallel between the sound generator and the loudspeakers for generation of a binaural acoustic sound signal emitted towards the eardrums of the user.

It is not fully known how the human auditory system extracts information about distance and direction to a sound source, but it is known that the human auditory system uses a number of cues in this determination. Among the cues are spectral cues, reverberation cues, interaural time differences (ITD), interaural phase differences (IPD) and interaural level differences (ILD).

The transmission of a sound wave from a sound source positioned at a given direction and distance in relation to the left and right ears of the listener is described in terms of two transfer functions, one for the left ear and one for the right ear, that include any linear distortion, such as coloration, interaural time differences and interaural spectral differences. Such a set of two transfer functions, one for the left ear and one for the right ear, is called a Head-Related Transfer Function (HRTF). Each transfer function of the HRTF is defined as the ratio between a sound pressure p generated by a plane wave at a specific point in or close to the appertaining ear canal (p_{L} in the left ear canal and p_{R} in the right ear canal) in relation to a reference. The reference traditionally chosen is the sound pressure p_{I} that would have been generated by a plane wave at a position right in the middle of the head with the listener absent.

The HRTF changes with direction and distance of the sound source in relation to the ears of the listener. It is possible to measure the HRTF for any direction and distance and simulate the HRTF, e.g. electronically, e.g. by a pair of filters. If such pair of filters are inserted in the signal path between a playback unit, such as a media player, e.g. the music players of the control device, and a hearing device used by a listener, the listener will have the perception that the sounds generated by the hearing device originate from a sound source positioned at a distance and in a direction as defined by the HRTF simulated by the pair of filters.

The HRTF contains all information relating to the sound transmission to the ears of the listener, including diffraction around the head, reflections from shoulders, reflections in the ear canal, etc., and therefore, due to the different anatomy of different individuals, the HRTFs are different for different individuals.

However, it is possible to provide general HRTFs which are sufficiently close to corresponding individual HRTFs for users in general to obtain the same sense of direction of arrival of a sound signal that has been filtered with pair of filters with the general HRTFs as of a sound signal that has been filtered with the corresponding individual HRTFs of the individual in question.

General HRTFs are disclosed in WO 93/22493.

For some directions of arrival, corresponding HRTFs may be constructed by approximation, for example by interpolating HRTFs corresponding to neighbouring angles of sound incidence, the interpolation being carried out as a weighted average of neighbouring HRTFs, or an approximated HRTF can be provided by adjustment of the linear phase of a neighbouring HTRF to obtain substantially the interaural time difference corresponding to the direction of arrival for which the approximated HRTF is intended.

For convenience, the pair of transfer functions of a pair of filters simulating an HRTF is also denoted a Head-Related Transfer Function even though the pair of filters can only approximate an HRTF.

Electronic simulation of the HRTFs by a pair of filters causes sound to be reproduced by the hearing device in such a way that the user perceives sound sources to be localized outside the head in specific directions.

The present invention relates to different aspects including the system described above and in the following, and corresponding methods, devices, systems, kits, uses and/or product means, each yielding one or more of the benefits and advantages described in connection with the first mentioned aspect, and each having one or more embodiments corresponding to the embodiments described in connection with the first mentioned aspect and/or disclosed in the appended claims.

In particular, disclosed herein is a hearing device configured to be used in a system for providing an acoustic environment for one or more users present in a physical area, e.g. according to the first mentioned aspect and/or according to the embodiments, where the hearing device is configured to be worn by a user present in the physical area, the hearing device having loudspeakers for emission of sound towards the ears of a user and accommodating an inertial measurement unit positioned for determining head yaw, when the user wears the hearing device in its intended operational position on the user's head, the hearing device comprising:
a GPS unit for determining the geographical position of the user,
a sound generator connected for outputting sound content from the control device to the loudspeakers, and
a pair of filters with a Head-Related Transfer Function connected between the sound generator and each of the loudspeakers in order to generate a binaural sound content emitted towards each of the eardrums of the user and perceived by the user as coming from one or more sound sources positioned in one or more directions corresponding to the selected Head Related Transfer Function.

In particular, disclosed herein is a control device configured to be used in a system for providing an acoustic environment for one or more users present in a physical area, e.g. according to the first mentioned aspect and/or according to the embodiments, where the control device is configured to be operated by the master, and where the control device comprises:
at least one sound source comprising the sound content;
a transmitter for wirelessly transmitting the sound content to the one or more wireless hearing devices configured to be worn by the one or more users;
   where the control device is configured for controlling the sound content transmitted to the one or more wireless hearing devices;
   where the control device is configured for controlling the apparent location of one or more virtual sound sources in the area in relation to the one or more users; and
   wherein the control device is configured for transmitting different sound content to different hearing devices worn by users or to hearing devices worn by different groups of users of the one or more users.

### BRIEF DESCRIPTION OF THE DRAWINGS

The above and/or additional objects, features and advantages of the present invention, will be further elucidated by the following illustrative and non-limiting detailed description of embodiments of the present invention, with reference to the appended drawings.

Below, the invention will be described in more detail with reference to the exemplary embodiments illustrated in the drawings, wherein

FIG. 1 shows a hearing device with an inertial measurement unit,

FIG. 2 shows (a) a head reference coordinate system and (b) head yaw,

FIG. 3 shows (a) head pitch and (b) head roll,

FIG. 4 is a block diagram of one embodiment of the hearing device,

FIG. 5 is a block diagram of one embodiment of the control device and

FIG. 6 is an example of the system for providing an acoustic environment for one or more users present in a physical area.

### DETAILED DESCRIPTION

The system for providing an acoustic environment for one or more users present in a physical area will now be described more fully hereinafter with reference to the accompanying drawings, in which various embodiments are shown. The accompanying drawings are schematic and simplified for clarity, and they merely show details which are essential to the understanding of the system for providing an acoustic environment for one or more users present in a physical area, while other details have been left out. The system for providing an acoustic environment for one or more users present in a physical area may be embodied in different forms not shown in the accompanying drawings and should not be construed as limited to the embodiments and examples set forth herein. Rather, these embodiments and examples are provided so that this disclosure will be thorough and complete, and will fully convey the scope of the invention to those skilled in the art.

Similar reference numerals refer to similar elements in the drawings.

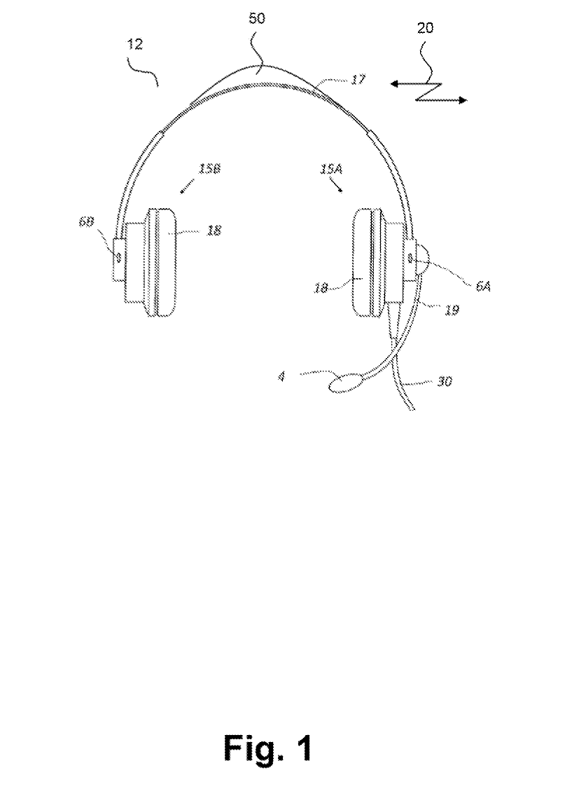

FIG. 1 shows a hearing device 12 of the system, having a headband 17 carrying two earphones 15A, 15B similar to a conventional corded headset with two earphones 15A, 15B interconnected by a headband 17.

Each earphone 15A, 15B of the illustrated hearing device 12 comprises an ear pad 18 for enhancing the user comfort and blocking out ambient sounds during listening or two-way communication.

A microphone boom 19 with a voice microphone 4 at the free end extends from the first earphone 15A. The microphone 4 is used for picking up the user's voice e.g. during two-way communication via a mobile phone network with for example another user of the system.

The housing of the first earphone 15A comprises a first ambient microphone 6A and the housing of the second earphone 15B comprises a second ambient microphone 6B.

The ambient microphones 6A, 6B are provided for picking up ambient sounds, which the user and/or the master can select to mix with the sound content received from the control device (not shown) controlled by the master (not shown).

When mixed-in, sound from the first ambient microphone 6A is directed to the speaker of the first earphone 15A, and sound from the second ambient microphone 6B is directed to the speaker of the second earphone 15B.

If the user carries a portable hand-held device, such as a mobile phone, a cord 30 extends from the first earphone 15A to the hand-held device (not shown).

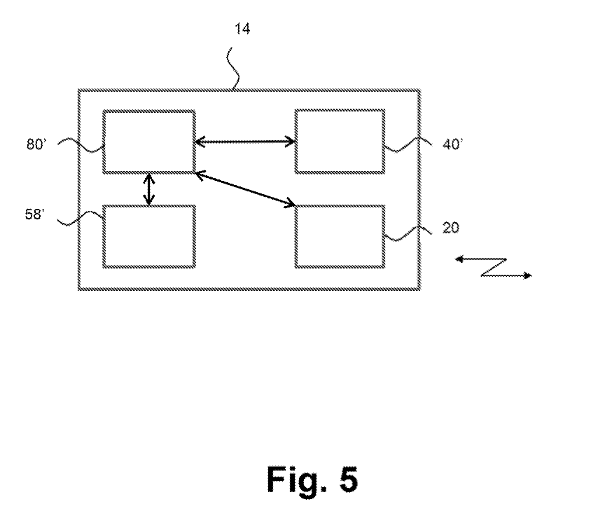

A wireless local area network (WLAN) transceiver in the hearing device 12 is wirelessly connected by a WLAN link 20 to a WLAN transceiver in the control device 14, see FIG. 5.

Alternatively and/or additionally a Bluetooth transceiver in the hearing device 12 is wirelessly connected by a Bluetooth link 20 to a Bluetooth transceiver in the control device 14 (not shown).

The cord 30 may be used for transmission of audio signals from the microphones 4, 6A, 6B to the hand-held device (not shown), while the WLAN and/or Bluetooth network may be used for data transmission of data from the inertial measurement unit 50 in the hearing device 12 to the control device 14 (not shown) and commands from the control device 14 (not shown) to the hearing device 12, such as turn a selected microphone 4, 6A, 6B on or off.

A similar hearing device 12 may be provided without a WLAN or Bluetooth transceiver so that the cord 30 is used for both transmission of audio signals and data signals; or, a similar hearing device 12 may be provided without a cord, so that a WLAN or Bluetooth network is used for both transmission of audio signals and data signals.

A similar hearing device 12 may be provided without the microphone boom 19, whereby the microphone 4 is provided in a housing on the cord as is well-known from prior art headsets.

A similar hearing device 12 may be provided without the microphone boom 19 and microphone 4 functioning as a headphone instead of a headset.

An inertial measurement unit 50 is accommodated in a housing mounted on or integrated with the headband 17 and interconnected with components in the earphone housings 15A and 15B through wires running internally in the headband 17 between the inertial measurement unit 50 and the earphones 15A and 15B.

The user interface of the hearing device 12 is not visible, but may include one or more push buttons, and/or one or more dials as is well-known from conventional headsets.

The orientation of the head of the user is defined as the orientation of a head reference coordinate system with relation to a reference coordinate system with a vertical axis and two horizontal axes at the current location of the user.

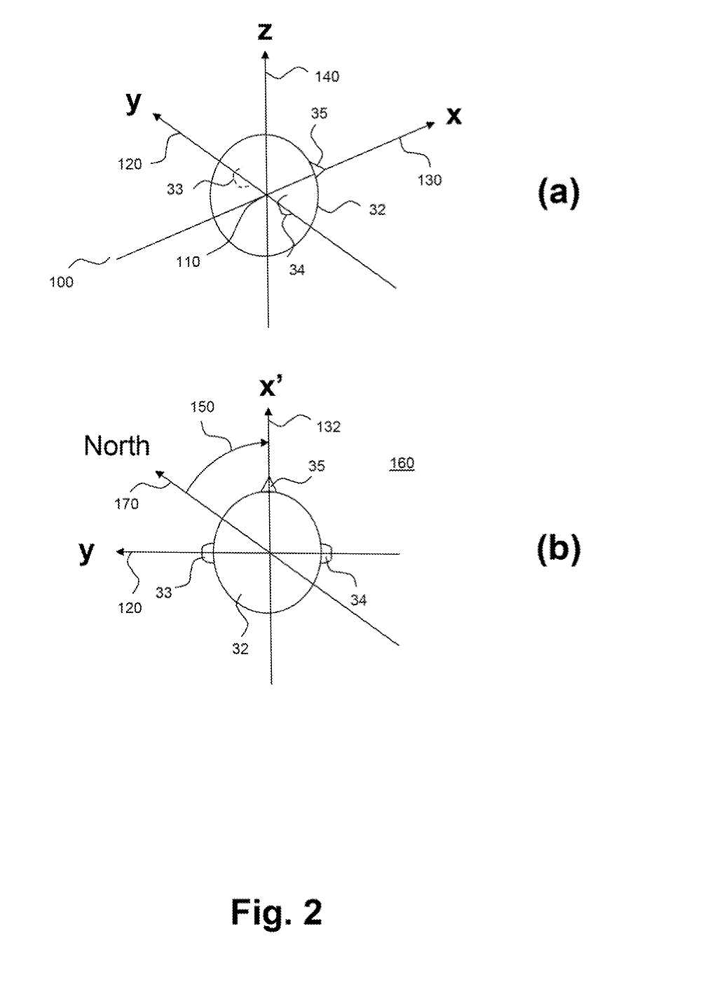

FIG. 2(a) shows a head reference coordinate system 100 that is defined with its centre 110 located at the centre of the user's head 32, which is defined as the midpoint 110 of a line 120 drawn between the respective centres of the eardrums (not shown) of the left and right ears 33, 34 of the user.

The x-axis 130 of the head reference coordinate system 100 is pointing ahead through a centre of the nose 35 of the user, its y-axis 120 is pointing towards the left ear 33 through the centre of the left eardrum (not shown), and its z-axis 140 is pointing upwards.

FIG. 2(b) illustrates the definition of head yaw 150. Head yaw 150 is the angle between the current x-axis' projection x′ 132 onto a horizontal plane 160 at the location of the user, and a horizontal reference direction 170, such as Magnetic North or True North.

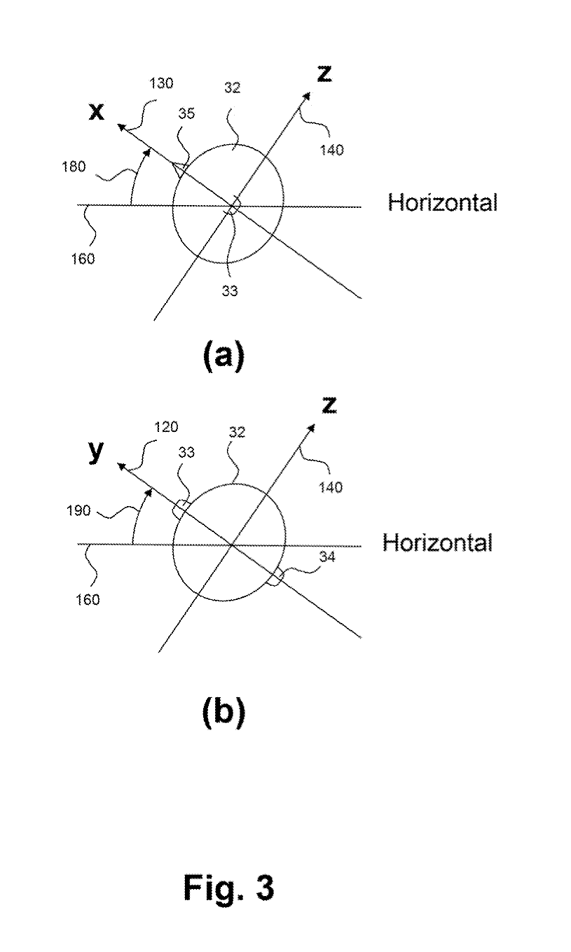

FIG. 3(a) illustrates the definition of head pitch 180. Head pitch 180 is the angle between the current x-axis 130 and the horizontal plane 160.

FIG. 3(b) illustrates the definition of head roll 190. Head roll 190 is the angle between the y-axis 120 and the horizontal plane.

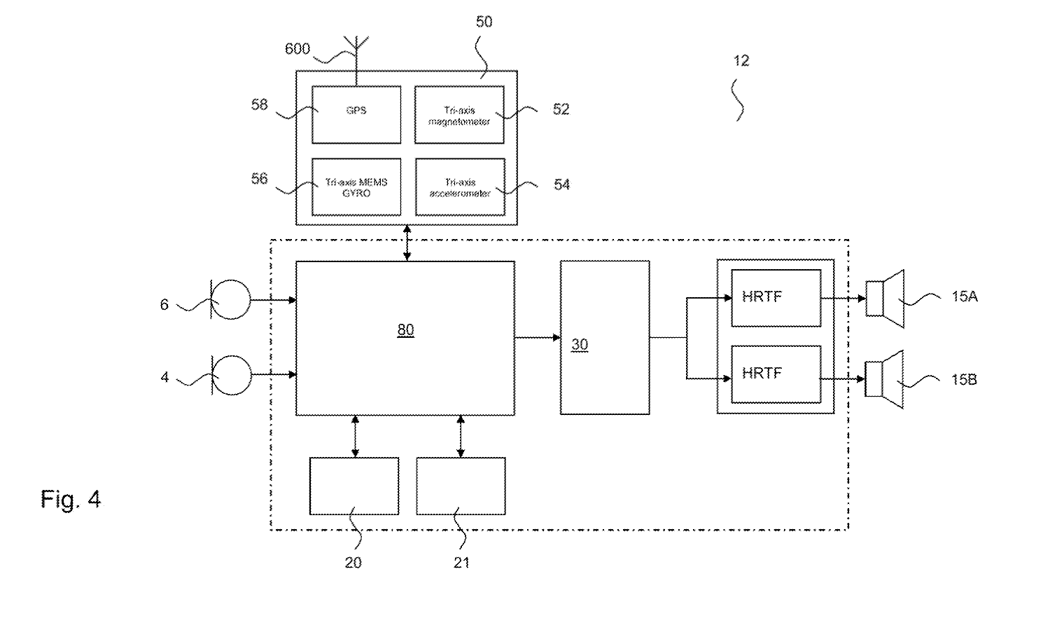

FIG. 4 shows a block diagram of a hearing device 12 of the system.

The illustrated hearing device 12 comprising electronic components including two earphones with loudspeakers 15A, 15B for emission of sound towards the ears of the user (not shown), when the hearing device 12 is worn by the user in its intended operational position on the user's head.

It should be noted that in addition to the hearing device 12 shown in FIG. 1, the hearing device 12 may be of any known type including an Ear-Hook, In-Ear, On-Ear, Over-the-Ear, Behind-the-Neck, Helmet, Headguard, etc, headset, headphone, earphone, ear defenders, earmuffs, etc.

Further, the hearing device 12 may be a binaural hearing aid, such as a BTE, a RIE, an ITE, an ITC, a CIC, etc, binaural hearing aid.

The illustrated hearing device 12 has a voice microphone 4 e.g. accommodated in an earphone housing or provided at the free end of a microphone boom mounted to an earphone housing.

The hearing device 12 further has one or two ambient microphones 6, e.g. at each ear, for picking up ambient sounds.

The hearing device 12 has an inertial measurement unit 50 positioned for determining head yaw, head pitch, and head roll, when the user wears the hearing device 12 in its intended operational position on the user's head.

The illustrated inertial measurement unit 50 has tri-axis MEMS gyros 56 that provide information on head yaw, head pitch, and head roll in addition to tri-axis accelerometers 54 that provide information on the three dimensional displacement of the hearing device 12.

The inertial measurement unit 50 also has a GPS-unit 58 for determining the geographical position of the user, when the user wears the hearing device 12 in its intended operational position on the head, based on satellite signals in the well-known way. Hereby, the user's current position and orientation can be provided to the master, the user and/or other users based on data from the hearing device 12.

Optionally, the hearing device 12 accommodates a GPS-antenna 600 configured for reception of GPS-signals, whereby reception of GPS-signals is improved in particular in urban areas where, presently, reception of GPS-signals can be difficult.

In a hearing device 12 without the GPS-unit 58, the hearing device 12 has an interface for connection of the GPS-antenna with an external GPS-unit, e.g. a hand-held GPS-unit, such as a mobile phone, whereby reception of GPS-signals by the hand-held GPS-unit is improved in particular in urban areas where, presently, reception of GPS-signals by hand-held GPS-units can be difficult.

The illustrated inertial measurement unit 50 also has a magnetic compass in the form of a tri-axis magnetometer 52 facilitating determination of head yaw with relation to the magnetic field of the earth, e.g. with relation to Magnetic North.

The hearing device 12 has a processor 80 with input/output ports connected to the sensors of the inertial measurement unit 50, and configured for determining and outputting values for head yaw, head pitch, and head roll, when the user wears the hearing device 12 in its intended operational position on the user's head.

The processor 80 may further have inputs connected to the accelerometers of the inertial measurement unit, and configured for determining and outputting values for displacement in one, two or three dimensions of the user when the user wears the hearing device 12 in its intended operational position on the user's head, for example to be used for dead reckoning in the event that GPS-signals are lost.

Thus, the illustrated hearing device 12 is equipped with a complete attitude heading reference system (AHRS) for determination of the orientation of the user's head that has MEMS gyroscopes, accelerometers and magnetometers on all three axes. The processor provides digital values of the head yaw, head pitch, and head roll based on the sensor data.

The hearing device 12 has a data interface 40 for transmission of data from the inertial measurement unit 50 to the processor 80 of the hearing device 12 and/or to a processor 80′, see FIG. 5, of the control device 14, see FIG. 5.

The hearing device 12 may further have a conventional wired audio interface for audio signals from the voice microphone 4, and for audio signals to the loudspeakers 15A, 15B for interconnection with a hand-held device, e.g. a mobile phone, with corresponding audio interface.

This combination of a low power wireless interface for data communication and a wired interface for audio signals provides a superior combination of high quality sound reproduction and low power consumption of the hearing device.

The hearing device 12 has a user interface 21 e.g. with push buttons and dials as is well-known from conventional headsets, for user control and adjustment of the hearing device 12 and possibly the hand-held device (not shown) interconnected with the hearing device 12, e.g. for selection of media to be played.

The hearing device 12 filters the output of a sound generator 30 of the hearing device 12 with a pair of filters with a head-related transfer function (HRTF) into two output audio signals, one for the left ear and one for the right ear of the hearing device 12, corresponding to the filtering of the HRTF of a direction in which the user turns. Different virtual sound sources may be received in the hearing device 12 depending on which direction the user is turned against. For example a virtual sound source in the form of drums may be heard from a direction of north, guitar may be heard form a direction of south, keyboard may be heard from a direction of east, etc. The HRTF may be applied to one or more sound sources thereby generating one or more virtual sound sources.

Alternatively and/or additionally the control device filters the sound content with a pair of head related transfer functions before the sound content is transmitted to the hearing device. The HRTF may be applied to the one or more sound sources in the control device, thereby generating one or more virtual sound sources.

This filtering process causes sound reproduced by the hearing device 12 to be perceived by the user as coming from a sound source localized outside the head from a direction corresponding to the HRTF in question.

The sound generator 30 may output audio signals representing any type of sound suitable for this purpose, such as speech, e.g. from an audio book, radio, etc, music, tone sequences, etc.

FIG. 5 shows an example of a block diagram of the control device 14. The control device 14 receives head yaw from the inertial measurement unit 50 of the hearing device 12 through the WLAN or Bluetooth Low Energy wireless interface 20. With this information, the control device 14 can display the position of each user on its display 40′.

Since the system may comprise more users, it is understood that the control device receives head yaw from the inertial measurement unit 50 of all the hearing devices 12 of all the users, and that the control device displays the position and orientation of all the users on its display. Thus when a user is mentioned, it is understood that this apply to all the users.

The control device 14 transmits sound content, such as music, to the hearing device 12, see FIG. 4, through the audio interface to the sound generator 30 of the hearing device through the wireless interface 20, as is well-known in the art, supplementing the other audio signals provided to the hearing device 12, such as one or more virtual sound sources of the system or speech from other users of the system.

The control device 14 has a processor 80′ with input/output ports connected to the display 40′ of the control device, to a GPS unit 58′ of the control device, and/or to a wireless transceiver 20.

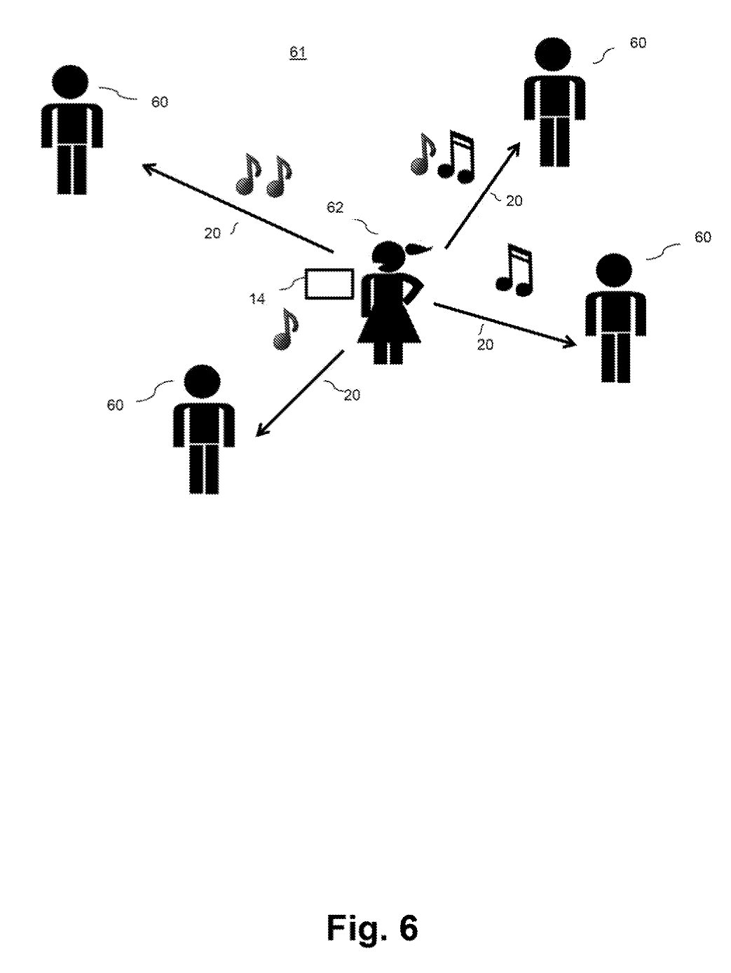

FIG. 6 illustrates the configuration and operation of an example of the system for providing an acoustic environment for one or more users 60 present in a physical area 61. Each user wears a wireless hearing device (not shown) which wirelessly receives 20 by means of e.g. a WLAN interface, a sound content, illustrated by the notes, from a control device 14 controlled by a master 62. The master 62 performs instructions for the processor 80′ of the control device 14 to perform the operations of the processor 80 of the hearing device 12 and of the pair of filters with an HRTF.

The control device 12 is configured for data communication with the hearing devices (not shown) through a wireless interface 20 available in the control device 14 and the hearing device 12, e.g. for reception of head yaw from the inertial measurement unit 50 of the hearing device 12.

The sound content is generated by a sound generator 30 of the hearing device 12, and the output of the sound generator 30 is filtered in parallel with the pair of filters with an HRTF so that an audio signal for the left ear and an audio signal for the right ear are generated. The filter functions of the two filters approximate the HRTF corresponding to the direction in which the user is turned.

Although some embodiments have been described and shown in detail, the invention is not restricted to them, but may also be embodied in other ways within the scope of the subject matter defined in the following claims. In particular, it is to be understood that other embodiments may be utilised and structural and functional modifications may be made without departing from the scope of the present invention.

In device claims enumerating several means, several of these means can be embodied by one and the same item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

The features of the system described above and in the following may be implemented in software and carried out on a data processing system or other processing means caused by the execution of computer-executable instructions. The instructions may be program code means loaded in a memory, such as a RAM, from a storage medium or from another computer via a computer network. Alternatively, the described features may be implemented by hardwired circuitry instead of software or in combination with software.

1. A system for providing an acoustic environment for one or more users present in a physical area, the system comprising:
one or more wireless hearing devices, where the one or more wireless hearing devices are configured to be worn by the one or more users, and where each wireless hearing device is configured to emit a sound content to the respective user;
a control device configured to be operated by a master, where the control device comprises:
at least one sound source comprising the sound content;
a transmitter for wirelessly transmitting the sound content to the one or more wireless hearing devices;
where the control device is configured for controlling the sound content transmitted to the one or more wireless hearing devices;
where the control device is configured for controlling the location of one or more virtual sound sources in the area in relation to the one or more users; and
wherein the control device is configured for transmitting different sound content to different hearing devices worn by users or to hearing devices worn by different groups of users of the one or more users.

2. The system according to claim 1, wherein the control device is configured for controlling the sound content in real time.

3. The system according to claim 1, wherein the sound content transmitted to a user is dependent on the user's physical position in the area.

4. The system according to claim 1, wherein the hearing device comprises a sound generator connected for outputting the sound content to the user via a pair of filters with a Head-Related Transfer Function and connected between the sound generator and a pair of loudspeakers of the hearing device for generation of a binaural sound content emitted towards the eardrums of the user.

5. The system according to claim 1, wherein the coordinates of the one or more virtual sound sources are transmitted to the processor of the hearing device, whereby the Head-Related Transfer Function is applied to the one or more virtual sound sources in the hearing device.

6. The system according to claim 1, wherein the Head-Related Transfer Function is applied to the sound content in the control device.

7. The system according to claim 1, wherein the control device continuously receives position data of the one or more users transmitted from the one or more hearing devices, respectively.

8. The system according to claim 1, wherein the apparent location of the one or more virtual sound sources is a part of/included in the sound content.

9. The system according to claim 1, wherein the apparent location of the one or more virtual sound sources is not part of/excluded/separate from the sound content.

10. The system according to claim 1, wherein the sound player of the control device comprises one or more music players, such as CD players, vinyl record players, laptop computers, and/or MP3 players.

11. The system according to claim 1, wherein the control device comprises an audio mixer configured for enabling the master to redirect music from a player, whose sound content is not outputted to the users, to the master hearing device so the master can preview/pre-hear an upcoming song.

12. The system according to claim 1, wherein the control device comprises a mixer comprising a crossfader configured for enabling the master to perform a transition from transmitting sound content from one music player to another music player.

13. The system according to claim 1, wherein the control device comprises audio sampling hardware and software, pressure and/or velocity sensitive pads configured to add instrument sounds, other than those coming from the music player, to the sound content transmitted to the one or more users.

14. The system according to claim 1, wherein the control device comprises a transmitter for wirelessly transmitting the sound content to the one or more hearing devices, and where the transmitter is a radio transmitter for outputting at least one wireless channel, where each wireless channel is configured for carrying the sound content and data pertinent to the location of the one or more virtual sound sources.

15. The system according to claim 1, wherein the system comprises a local indoor positioning system/indoor location system for determining the position of each of the users in the area.

16. The system according to claim 1, wherein the control device comprises means to rhythmically synchronize at least two sound players having different sound content, where the means to rhythmically synchronize at least two sound players comprises providing beat matching of the sound content for one or more users or one or more groups of users, whereby the users hear different music but with the same beat.
